(19) United States
(12) Patent Application Publication
(10) Pub. No.: US 2015/0055675 A1
(43) Pub. Date: Feb. 26, 2015

(54) METHOD FOR DETERMINING COMPOSITION OF A MULTI-COMPONENT MEDIUM

(71) Applicant: SCHLUMBERGER TECHNOLOGY CORPORATION, SUGAR LAND, TX (US)

(72) Inventor: EVGENY NIKOLAEVICH DYSHLYUK, DHAHRAN (SA)

(21) Appl. No.: 14/462,385

(22) Filed: Aug. 18, 2014

(30) Foreign Application Priority Data
Aug. 23, 2013 (RU) 2013139142

(51) Int. Cl. G01K 17/00

(52) U.S. Cl. CPC G01K 17/00
USPC 374/31

(57) ABSTRACT

Methods to determine a quantitative composition of a multi-component medium are described. These methods provide for placing a sample into a cell of a differential scanning calorimeter and injecting a liquid into the cell, the liquid has a known volume thermal expansion coefficient and a known volume heat capacity. A total heat capacity and a total volume thermal expansion coefficient are determined for the sample and the fluid inside the cell. Solving system of equations it is possible to determine volumes of components composing the sample.

### CROSS-REFERENCE TO RELATED APPLICATION

This application claims priority to Russian Patent Application No. 2013139142 filed Aug. 23, 2013, which is incorporated herein by reference in its entirety.

### BACKGROUND

The disclosure relates to the field of analysis of multi-component media properties, such as porous, fluid-saturated bodies, fluid-saturated core samples of rock formations, various fluid saturated powders, or other porous bodies, and may find applications in various industries, such as in the petrochemical and chemical industries.

A quantitative composition of a medium is one of the most important characteristics of multi-component media. For example, in analysis of rock core properties it is of interest to determine volumes of all (solid, liquid, and gaseous) phase components present in the sample. Of particular interest are derivatives of these values such as, for example, porosity or fluid-saturation coefficients.

A fluid-saturation coefficient of a porous medium (under fluid L we imply any liquid or gas) S_{L} is equal to a volume of the fluid occupying pores of the porous body V_{L} to a total volume of a void (porous) space of the body Vₚ:

$${S}_{L} = \frac{{V}_{L}}{{V}_{P}} .$$

The fluid-saturation coefficient is an important parameter characterizing the porous medium and fluids filling the body. Thus, for example, oil- and water-saturation coefficients (or saturation coefficient of mineralized water) are used in the petrochemical industry. The evaluation of these parameters is required, for example, to calculate oil reserves, to predict the optimal oil production rate; these parameters are necessary to conduct laboratory studies using rock core samples. For example, initial oil-, water-, and gas-saturation of a core sample recovered from a wellbore are usually studied in petrophysics laboratory studies. These coefficients are also important values to be measured during experiments to estimate a capillary pressure using a semi-permeable membrane and/or to study phase permeabilities through joint filtration of fluids through a rock core sample.

Different methods are used for measuring fluid-saturation coefficients.

A direct method for determining initial water- and oil-saturation in rock samples recovered from a wellbore through removal of water and oil using extraction-distillation technique is well known (Determination of the physics properties of oil bearing rock, Gudok N. S., Bogdanovich N. N., Martynov V. G., Moscow, Nedra-Business Center LLC, 2007, pp. 87-91). This method, however, is time-consuming and labor-intensive.

There is also a direct method for determining fluid-saturation of a core sample by measuring a volume or weight of fluids injected into a core sample and fluids coming out of the sample (see, e.g., Saraf, D. N. et al in An Experimental Investigation of Three-Phase Flow of Water-Oil-Gas Mixtures Through Water-Wet Sandstone, paper SPE 10761 presented at the SPE 1982 California Regional Meeting, San Fran-Francisco, March 24-26). The disadvantage of volumetric and gravimetric methods deals with their low accuracy when pumping large amounts of fluid through the core sample. In addition, it is not always possible to adapt these methods to the measurements under conditions of high pressure and temperature.

An indirect method of measuring water saturation of core samples by measuring electrical resistance of a core sample is known (Leverett, M. C. and Lewis, W. B.: Steady Flow of Gas-Oil-Water Mixtures Through Unconsolidated Sands, Trans. AI ME (1941) 142, 107-16). The disadvantage of this method is its low accuracy and effects of various rock wettability coefficients affecting value of the fluid saturation.

An indirect method for determination of water saturation (RU 2315978 C1) and oil saturation (RU 2360233 C1) of rock using X-ray absorption spectroscopy is known. This method requires expensive instruments.

An indirect method for determination of oil- and water-saturation of rocks by study of a nuclear magnetic resonance signal (RU 2175764 C2) is known. This method requires expensive instruments.

### SUMMARY

A first embodiment of the disclosure provides for measuring a mass and a volume of a sample of a multi-component medium, then the sample is placed in a cell of a differential scanning calorimeter. The calorimeter cell is filled with a liquid having a known volume heat expansion coefficient and a known volume heat capacity. Sequential increase and decrease of temperature in the calorimeter cell is performed and a thermal effect produced by said increase and decrease of temperature is measured. Then a total heat capacity of the sample and the liquid is calculated. By injecting a liquid into the cell pressure in the cell containing the sample is increased and decreased step by step and a thermal effect produced by said pressure increase and decrease is measured. A total volume coefficient of thermal expansion of the sample and the liquid is calculated. Volumes of components comprising the sample are calculated through solving the following system of linear algebraic equations:

$$\begin{matrix}v = {\sum }_{i = 1}^{n} {v}_{i} \\ m = {\sum }_{i = 1}^{n} {ρ}_{i} {v}_{i} \\ c = {\sum }_{i = 1}^{n} {c}_{i} {v}_{i} + {c}_{l} {v}_{l} \\ α = {\sum }_{i = 1}^{n} {α}_{i} {v}_{i} + {α}_{l} {v}_{l}\end{matrix} , \qquad ( 1 )$$

where n is a number of the components of the sample, vᵢ—are volumes of the components of the sample, ρᵢ—are densities of the components of the sample; cᵢ—are volume heat capacities of the components of the sample, αᵢ—are thermal volume expansion coefficients of the components of the sample, v—is a volume of the sample, m is the sample mass, α—is the total thermal volume expansion coefficient of the sample and the liquid having the known thermal expansion coefficient and the known volume heat capacity inside the cell, c—is the total heat capacity of the sample and the liquid having the known thermal expansion coefficient and the known volume heat capacity inside the cell, vₗ—is a volume of the cell filled with the liquid having the known thermal volume expansion coefficient and the known volume heat capacity, αₗ—is a volume heat expansion coefficient of the liquid having the known thermal volume expansion coefficient and the known volume heat capacity, cₗ—is a volume heat capacity of the liquid having the known thermal volume expansion coefficient and the known volume heat capacity.

According to one of embodiments of the disclosure after filling the calorimeter cell with the liquid having the known volume thermal expansion coefficient and the known volume heat capacity the cell with the sample is kept until the heat flow is stabilized.

According to another embodiment of the disclosure after each increase and decrease in temperature the cell with the sample is kept until the heat flow is stabilized.

According to another embodiment of the disclosure after each increase and decrease in pressure the cell with the sample is kept until the heat flow is stabilized

According to an embodiment of the disclosure a rock core is used as the sample.

Water, liquid hydrocarbon, or any liquid component present in the core sample can be used as the liquid having the known thermal volume expansion coefficient and the known volume heat capacity.

In accordance with another embodiment of the disclosure mass, volume and heat capacity of a sample of the multi-component medium are measured and the sample is placed into a cell of a differential scanning calorimeter. Pressure in the cell is increased and decreased step-by-step by injecting a liquid into the cell, the liquid having a known thermal volume expansion coefficient. A heat effect resulting from increasing and decreasing pressure in the cell is measured. A total thermal volume expansion coefficient for the sample and the liquid having the known thermal volume expansion coefficient inside the cell is calculated and volumes of components of the sample are determined by solving the following system of equations

$$\begin{matrix}v = {\sum }_{i = 1}^{n} {v}_{i} \\ m = {\sum }_{i = 1}^{n} {ρ}_{i} {v}_{i} \\ c = {\sum }_{i = 1}^{n} {c}_{i} {v}_{i} \\ α = {\sum }_{i = 1}^{n} {α}_{i} {v}_{i} + {α}_{l} {v}_{l}\end{matrix} \qquad ( 2 )$$

where n is a number of the components of the sample, vᵢ—are volumes of the components of the sample, ρᵢ—are densities of the components of the sample; cᵢ—are volume heat capacities of the components of the sample, αᵢ—are coefficients of thermal volume expansion of the components of the sample, v—is a volume of the sample, m—is the sample mass, α—is the total thermal volume expansion coefficient of the sample and the liquid having the known thermal volume expansion coefficient inside the cell, c—is the total heat capacity of the sample and liquid having the known thermal volume expansion coefficient inside the cell, vₗ—is a volume of the cell to be filled with the liquid having the known thermal volume expansion coefficient, αₗ is the thermal volume expansion coefficient of the liquid.

In accordance with another embodiment of the disclosure a volume of a sample of the multi-component medium is measured and the sample is placed into a cell of a differential scanning calorimeter. The cell is filled with a liquid having a known thermal volume expansion coefficient and a known volume heat capacity. Temperature of the cell is increased and decreased step-by-step and an effect heat resulting from the temperature increase and decrease in the cell is measured. A total heat capacity for the sample and the liquid having the known thermal volume expansion coefficient and the known volume heat capacity contained inside the cell is calculated. Pressure in the cell is increased and decreased step by step by injecting a liquid in the cell and a heat effect produced by increasing and decreasing pressure in the cell is measured. A total thermal volume expansion coefficient for the sample and the liquid having the known thermal expansion coefficient and the known volume heat capacity inside the cell is calculated. Volumes of components of the sample are determined by solving the system of linear algebraic equations:

$$\begin{matrix}v = {\sum }_{i = 1}^{n} {v}_{i} \\ c = {\sum }_{i = 1}^{n} {c}_{i} {v}_{i} + {c}_{l} {v}_{l} \\ α = {\sum }_{i = 1}^{n} {α}_{i} {v}_{i} + {α}_{l} {v}_{l}\end{matrix} , \qquad ( 3 )$$

where n—is a number of the components of the sample, vᵢ—volumes of the components of the sample, ρᵢ—densities of the components of the sample; cᵢ—are volume heat capacities of the components of the sample, αᵢ—are thermal volume expansion coefficients of the components of the sample, v—is the volume of the sample, α—is the thermal volume expansion coefficient of the sample and the liquid having the known thermal volume expansion coefficient and the known volume heat capacity inside the cell, c—is the total heat capacity of the sample and the liquid having the known thermal volume expansion coefficient and the known volume heat capacity inside the cell, vₗ—is a volume of the cell filled with the liquid having the known thermal volume expansion coefficient and the known volume heat capacity, αₗ—is the thermal volume expansion coefficient of the liquid having the known thermal volume expansion coefficient and the known volume heat capacity, cₗ—is the volume heat capacity of the liquid having the known thermal volume expansion coefficient and the known volume heat capacity.

### BRIEF DESCRIPTION OF DRAWINGS

The disclosure is illustrated by drawings where:

FIG. 1 shows a schematic diagram of a typical differential scanning calorimeter.

FIG. 2 shows a profile of sample temperature and heat flow with measurement of heat capacity and measurable thermal effect (hatched area).

FIG. 3 shows the change in heat flow and the thermal effect produced upon a staged change in pressure.

### DETAILED DESCRIPTION

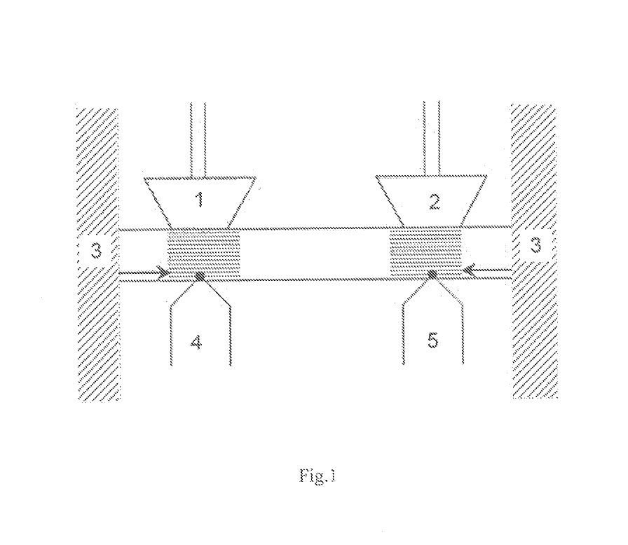

A typical differential-scanning calorimeter (DSC) (see FIG. 1) is equipped with two cells, one of which (cell 1) contains a sample being studied. The other cell 2 is a control cell; depending on the experiment it can remain empty or be filled. The cells have reliable temperature insulation; they are kept at a controlled temperature which can be changed using a heater 3 of the calorimeter. Measurement of the temperature differential between each cell and the calorimeter chamber is usually carried out using thermocouples 4 and 5. The accurate calibration of the calorimeter enables calculation of the difference in heat flows between the calorimeter cells and the calorimeter chamber. Integrating heat flows in time allows determination of the difference in the amount of heat generated or absorbed in each cell. DSC are able to operate at different temperatures (the temperature range depends on the calorimeter model); some DSC models can be equipped with cells which enable measurements under elevated pressures. To conduct measurements outlined in this disclosure, it is necessary to combine DSC with a system capable of creating controlled pressure inside the calorimeter cells. To provide such a system, various types of pumps combined with pressure sensors and pipe-connectors can be used to connect the system to the cells of the calorimeter.

As an example embodiments of the disclosure are described below for rock core sample analysis. In the study of initial or ongoing oil-, water- and gas-saturation in a core sample, it is of interest to determine a quantitative composition of all four components, i.e. solid component (rock), oil, water, and gas. The number of components can be less, if for example gas, water or oil are absent in the sample.

According to the first embodiment of the disclosure, a mass and a volume of a sample of a multi-component medium, such as a rock core sample, is measured. The sample is placed into a cell 1 of DSC. The cell is filled with a liquid having a known volume thermal expansion coefficient and a known volume heat capacity; for example, water, liquid hydrocarbons, or any liquid component already present in the core sample as a component. Thus, for example, in the study of the core sample, as a rule, there are samples of oil and mineral solution saturating the core sample. The process of filling the cell with the liquid having the known volume thermal expansion coefficient and the known volume heat capacity can be used to experiment with multiphase filtration, or with displacement of liquids from the sample.

To determine a volume heat capacity of the sample and the liquid filling the calorimeter cell, temperature in the cell is increased and decreased in sequential manner and a thermal effect produced by increasing and decreasing the temperature is measured. A volume heat capacity of a body (c) is a physical value determining ratio of an infinitely small amount of heat received by a unit of a volume of the body to the corresponding increase in temperature. Methods for determining volume heat capacity of the body using DSC are well-known (see, for example, Experimental evaluation of procedures for heat capacity measurement by differential scanning calorimetry Ramakumar K., Saxena M., Deb S. Journal of Thermal Analysis and calorimetry, V.66, Iss. 2, 2001, pp. 387-397).

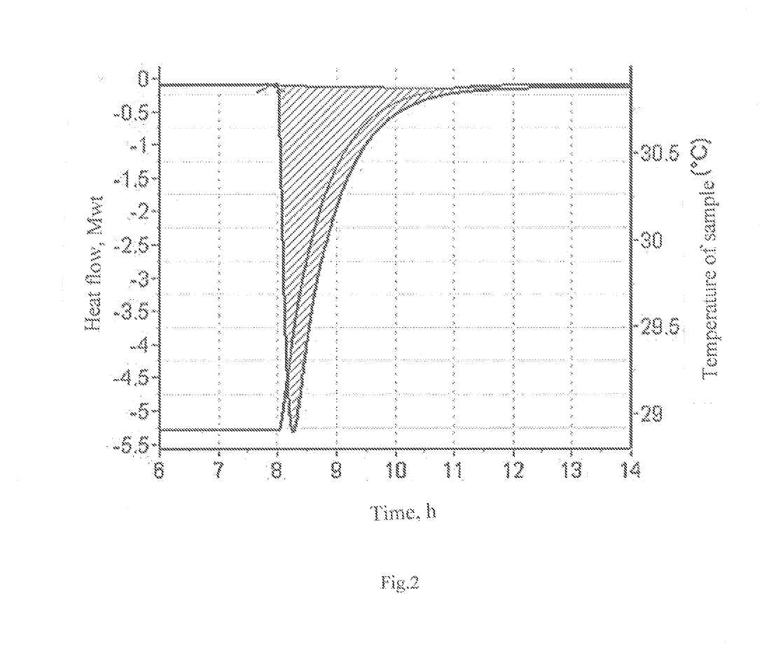

To determine heat capacity by DSC, three experiments are usually performed—one experiment with an empty cell, the second experiment with a cell filled with a reference sample with a known volume heat capacity (c_{R}) that is close to the heat capacity of the body, and the third experiment directly involving the studied sample. In the course of all these experiments temperature of a heating chamber of the calorimeter containing the measuring cell is changed and the change of heat flow is recorded. Summing of the heat flow over time allows to determine total thermal effect. In order to increase the accuracy of heat capacity measurements it is recommended to use a method by which the temperature is changed in a staged manner, i.e. making use of two isothermal intervals: the first—prior to the temperature increase and the second—after the temperature increase; the second interval should be long enough to ensure stabilization of the heat flow. An area between a curve of the heat flow and a base line corresponds to the measured thermal effect. The heat capacity of the object in question is determined using the following formula:

$$c = \frac{{c}_{R} ( {Q}_{S} - {Q}_{B} )}{( {Q}_{R} - {Q}_{B} )} ,$$

where Q_{S}, Q_{B}, Q_{R}—are total thermal effects obtained in experiments with the sample, without the sample and with the reference sample, respectively. FIG. 2 shows temperature and heat flow profiles obtained in experiments to measure the heat capacity and the thermal effect (hatched area).

To determine a total volume thermal expansion coefficient (VTEC) of the sample and the liquid that fills the calorimeter cell, the step-like increase and decrease of pressure in the sample cell is carried out by injecting a liquid into the cell; the liquid has a known volume thermal expansion coefficient and a known volume heat capacity; this is followed by measuring a thermal effect produced by the pressure increase and decrease. According to one embodiment it is used the same liquid with a known volume thermal expansion coefficient and a known volume heat capacity that was used to fill the cell.

A volume thermal expansion coefficient is a physical value describing the relative change in the body volume as a result of temperature increase by one degree at a constant pressure:

$$α = \frac{1}{V} {( \frac{d V}{d T} )}_{p} ,$$

where V is a volume, T is temperature, and p is pressure. VTEC has dimension inverse to temperature.

VTEC is an important thermodynamic parameter describing properties of liquids. This parameter is often required to describe models of liquids, for example, to simulate properties of oil and gas deposits in the oil industry. For a given material VTEC depends on temperature and pressure. For example, the methods to measure VTEC using DSC are described in U.S. Pat. No. 6,869,214 B2, or in a paper S. Verdier, S. I. Andersen Determination of Isobaric Thermal Expansivity of Organic Compounds from 0.1 to 30 MPa at 30° C. with an Isothermal Pressure Scanning Microcalorimeter.

When pressure in the calorimeter cell is increased by liquid injection, a measured total thermal effect δQ is associated with VTEC of the sample inside the cell—a, with VTEC of the cell material α_{c}, with the cell temperature T, with the volume V of liquid inside the cell as well as with the incremental step of pressure change dP as follows:

$$α = {α}_{c} + \frac{δ Q}{{dP}_{VT}} .$$

If VTEC is not known in advance for the material inside the cell, it can be determined experimentally. In an additional experiment a part of the liquid in the cell is replaced by a body (R) with a known volume v_{ref} and VTEC α_{ref} and the same experiment is conducted. VTEC of the sample and VTEC of the material from which the calorimeter cell is made can be found from the following equations:

$$α = \frac{1}{{V}_{ref} T} ( \frac{δ {Q}_{1}}{{dP}_{1}} - \frac{δ {Q}_{2}}{{dP}_{1}} ) + {α}_{ref}$$

$${α}_{c} = α - \frac{δ {Q}_{1}}{V ( p ) {TdP}_{1}}$$

where δQ₁ is a total thermal effect when the calorimeter cell contains the sample analyzed, dP₁—is the pressure change when the calorimeter cell contains the sample analyzed, δQ₂—is the total thermal effect, when the calorimeter cell contains the sample analyzed, part of the sample is replaced by a body with a known volume thermal expansion coefficient, dP₂—is the pressure change when the calorimeter cell contains the sample analyzed, and its part is replaced by a body with a known volume thermal expansion coefficient.

According to one embodiment of the disclosure in order to improve the measurement accuracy the VTEC of the body is close to the VTEC of the sample.

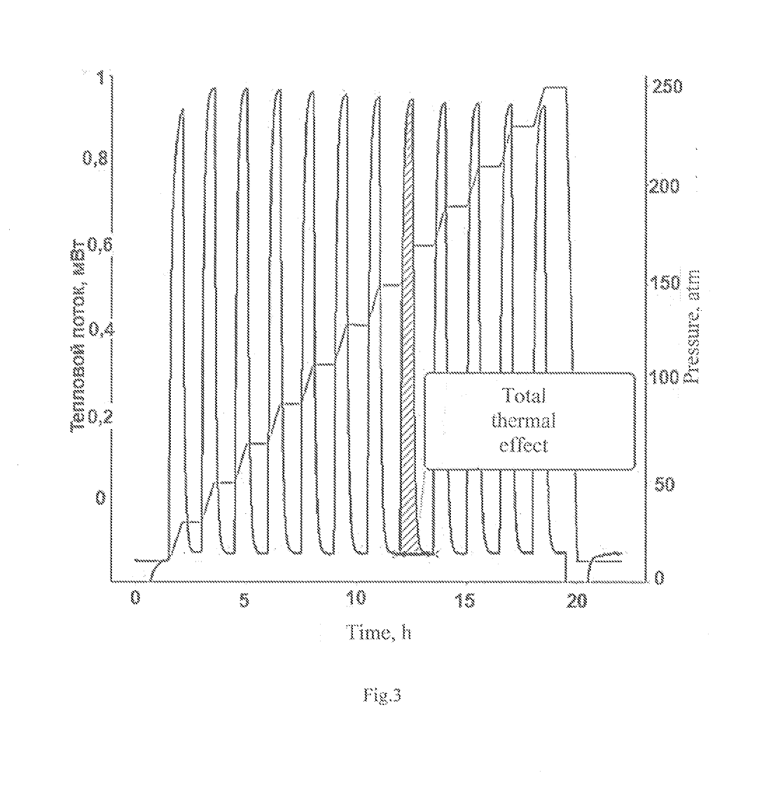

FIG. 3 shows the change in the heat flow and the thermal effect (hatched area) obtained by the step by step pressure increase.

This is followed by solving the system of equations (1) and finding volumes of components comprising the sample. The data on density, volume heat capacity and VTEC can be taken for each component from the table values or measured separately. Thus, for instance, the studies of core samples usually imply having preliminary information about composition of the solid phase; in addition, there are usually samples of liquids (oil, mineral solution) saturating the core available; these samples can be used to measure the parameters of interest using known methods, including DSC.

According to another embodiment of the disclosure a mass, a volume and a heat capacity of a multi-component medium (e.g., a sample of rock core) are measured. The heat capacity can be determined using the calorimetry method; it was described above with respect to the first embodiment of the disclosure. The sample is then placed into a cell 1 of a DSC. By injecting a liquid with a known volume thermal expansion coefficient (this can be, for example, water, liquid hydrocarbon or any liquid component of the sample) into the cell, pressure is increased and decreased step by step. A thermal effect associated with changing pressure is measured and VTEC is calculated for the sample and the liquid inside the calorimeter cell in the same manner as was described for the first embodiment of the invention.

The system of equations (2) is then solved and volumes of components comprising the sample are found. The data on density, volume heat capacity and VTEC can be taken for each component from the table values or can be measured separately. For example, preliminary information on composition of a solid phase is usually available in the studies of rock core samples; moreover, there are samples of fluids (oil, mineral solution) saturating the core available before the studies and parameters of interest can be measured in these samples using known (including DSC) techniques.

The third embodiment of the disclosure comprises measuring a volume of a sample of a multi-component medium, for example, a sample of a rock core. The sample is placed into a cell 1 of a DSC. A remaining free cell volume is filled with a liquid with a known volume thermal expansion coefficient and a known volume heat capacity; for example, this can be water, liquid hydrocarbons or any of the liquid components comprising the core. Thus, for example, in the study of the core sample, as a rule, samples of the oil and mineral solution saturating the core sample are available. The liquid inside the sample is then displaced by another liquid, or the liquid is pumped (filtered) through the sample.

VTEC is measured for the sample and the liquid inside the calorimeter cell; measuring VTEC is identical to the procedures described with respect to the first embodiment of the invention.

The system of equations (3) is solved and volumes of components comprising the sample are determined. The data on the density, volume heat capacity and VTEC can be taken for each component from the table values or measured separately. For example, preliminary information on the composition of the solid phase is usually available in the studies of rock core samples; moreover, there are samples of fluids (oil, mineral solution) saturating the core available before the studies begin, and parameters of interest can be measured in these samples using known (including DSC) techniques.

1. A method for determining composition of a multi-component medium comprising:
measuring a mass and a volume of a sample of the multi-component medium;
placing the sample into a cell of a differential scanning calorimeter;
filling the cell with a liquid having a known volume heat expansion coefficient and a known volume heat capacity;
increasing and decreasing a temperature of the cell in a sequential manner;
measuring a heat effect in the cell produced by increasing and decreasing the temperature;
calculating a total heat capacity for the liquid having the known heat expansion coefficient and the known volume heat capacity and the sample inside the cell;
increasing and decreasing pressure in the cell with the sample step by step by injecting a liquid into the cell;
measuring a heat effect resulting from increasing and decreasing the pressure;
calculating a total thermal volume expansion coefficient for the sample and the liquid having the known thermal expansion coefficient and the known volume heat capacity inside the cell; and
determining volumes of components of the sample solving the following system of equations:
$$\begin{matrix}v = {\sum }_{i = 1}^{n} {v}_{i} \\ m = {\sum }_{i = 1}^{n} {ρ}_{i} {v}_{i} \\ c = {\sum }_{i = 1}^{n} {c}_{i} {v}_{i} + {c}_{l} {v}_{l} \\ α = {\sum }_{i = 1}^{n} {α}_{i} {v}_{i} + {α}_{l} {v}_{l}\end{matrix}$$
where n is a number of the components of the sample, vᵢ—are volumes of the components of the sample, ρᵢ—are densities of the components of the sample; cᵢ—are volume heat capacities of the components of the sample, αᵢ—are thermal volume expansion coefficients of the components of the sample, v—is a volume of the sample, m is the sample mass, α—is the total thermal volume expansion coefficient of the sample and the liquid having the known thermal expansion coefficient and the known volume heat capacity inside the cell, c—is the total heat capacity of the sample and the liquid having the known thermal expansion coefficient and the known volume heat capacity inside the cell, vₗ—is a volume of the cell filled with the liquid having the known thermal volume expansion coefficient and the known volume heat capacity, αₗ—is a volume heat expansion coefficient of the liquid having the known thermal volume expansion coefficient and the known volume heat capacity, cₗ—is a volume heat capacity of the liquid having the known thermal volume expansion coefficient and the known volume heat capacity.

2. The method of claim 1 wherein after filling the cell with the liquid having the known volume heat expansion coefficient and the known volume heat capacity the cell with the sample is kept until the heat flow is stabilized.

3. The method of claim 1 wherein after each increase and decrease in temperature the cell with the sample is kept until the heat flow is stabilized.

4. The method of claim 1 wherein after each increase and decrease in pressure the cell with the sample is kept until the heat flow is stabilized

5. The method of claim 1 wherein the increase and decrease in pressure inside the cell with the sample is obtained by injecting the liquid used to fill the cell and having the known thermal volume expansion coefficient and the known volume heat capacity.

6. The method of claim 1 wherein a rock core is used as the sample.

7. The method of claim 1 wherein water is used as the liquid having the known thermal volume expansion coefficient and the known volume heat capacity.

8. The method of claim 1 wherein liquid hydrocarbon is used as the liquid having the known thermal volume expansion coefficient and the known volume heat capacity.

9. The method of claim 1 wherein any liquid component of the sample is used as the liquid having the known thermal volume expansion coefficient and the known volume heat capacity.

10. A method of claim 1 for determining a composition of a multi-component medium comprising:
measuring a mass, a volume and a heat capacity of a sample of the multi-component medium,
placing the sample into a cell of a differential scanning calorimeter,
increasing and decreasing pressure in the cell step by step by injecting a liquid into the cell, the liquid having a known thermal volume expansion coefficient,
measuring a heat effect resulting from increasing and decreasing pressure in the cell,
calculating a total thermal volume expansion coefficient for the sample and the liquid having the known thermal volume expansion coefficient inside the cell, and
determining volumes of components of the sample by solving the following system of equations
$$\begin{matrix}v = {\sum }_{i = 1}^{n} {v}_{i} \\ m = {\sum }_{i = 1}^{n} {ρ}_{i} {v}_{i} \\ c = {\sum }_{i = 1}^{n} {c}_{i} {v}_{i} \\ α = {\sum }_{i = 1}^{n} {α}_{i} {v}_{i} + {α}_{l} {v}_{l}\end{matrix}$$
where n is a number of the components of the sample, vᵢ—are volumes of the components of the sample, ρᵢ—are densities of the components of the sample; cᵢ—are volume heat capacities of the components of the sample, αᵢ—are coefficients of thermal volume expansion of the components of the sample, v—is a volume of the sample, m—is the sample mass, α—is the total thermal volume expansion coefficient of the sample and the liquid having the known thermal volume expansion coefficient inside the cell, c—is the total heat capacity of the sample and liquid having the known thermal volume expansion coefficient inside the cell, vₗ—is a volume of the cell to be filled with the liquid having the known thermal volume expansion coefficient, αₗ is the thermal volume expansion coefficient of the liquid.

11. The method of claim 10 wherein after each step of the pressure increase and decrease the cell with the sample is kept until the heat flow is stabilized.

12. The method of claim 10 wherein a rock core is used as the sample.

13. The method of claim 10 wherein water is used as the liquid having the known thermal volume expansion coefficient.

14. The method of claim 10 wherein liquid hydrocarbon is used as the liquid having the known thermal expansion coefficient.

15. The method of claim 10 wherein any liquid component of the sample is used as the liquid having the known thermal volume expansion coefficient.

16. A method for determining a composition of a multi-component medium comprising:
measuring a volume of a sample of the multi-component medium;
placing the sample into a cell of a differential scanning calorimeter;
filling the cell with a liquid having a known thermal volume expansion coefficient and a known volume heat capacity;
increasing and decreasing temperature of the cell step by step;
measuring an effect heat resulting from the temperature increase and decrease in the cell;
calculating a total heat capacity for the sample and the liquid having the known thermal volume expansion coefficient and the known volume heat capacity contained inside the cell;
increasing and decreasing pressure in the cell step by step by injecting a liquid in the cell;
measuring a heat effect produced by increasing and decreasing pressure in the cell;
calculating a total thermal volume expansion coefficient for the sample and the liquid having the known thermal expansion coefficient and the known volume heat capacity inside the cell; and
determining volumes of components of the sample by solving the following system of equations:
$$\begin{matrix}v = {\sum }_{i = 1}^{n} {v}_{i} \\ c = {\sum }_{i = 1}^{n} {c}_{i} {v}_{i} + {c}_{l} {v}_{l} \\ α = {\sum }_{i = 1}^{n} {α}_{i} {v}_{i} + {α}_{l} {v}_{l}\end{matrix} ,$$
where n—is a number of the components of the sample, vᵢ—volumes of the components of the sample, ρᵢ—densities of the components of the sample; cᵢ—are volume heat capacities of the components of the sample, αᵢ13 are thermal volume expansion coefficients of the components of the sample, v—is the volume of the sample, α—is the thermal volume expansion coefficient of the sample and the liquid having the known thermal volume expansion coefficient and the known volume heat capacity inside the cell, c—is the total heat capacity of the sample and the liquid having the known thermal volume expansion coefficient and the known volume heat capacity inside the cell, vₗ—is a volume of the cell filled with the liquid having the known thermal volume expansion coefficient and the known volume heat capacity, αₗ—is the thermal volume expansion coefficient of the liquid having the known thermal volume expansion coefficient and the known volume heat capacity, cₗ—is the volume heat capacity of the liquid having the known thermal volume expansion coefficient and the known volume heat capacity.

17. The method of claim 16 wherein after filling the cell with the liquid having the known volume heat expansion coefficient and the known volume heat capacity the cell with the sample is kept until the heat flow is stabilized.

18. The method of claim 16 wherein after each step of temperature increase and decrease the cell with sample is kept until the heat flow is stabilized.

19. The method of claim 16 wherein after each step of pressure increase and decrease the cell with the sample is kept until the heat flow is stabilized.

20. The method of claim 16 wherein increase and decrease in pressure inside the cell containing the sample is made by injecting the liquid used to fill the cell and having the known thermal volume expansion coefficient and the known volume heat capacity.

21. The method of claim 16 wherein a rock core is used as the sample.

22. The method of claim 16 wherein water is used as the liquid having the known thermal volume expansion coefficient and the known volume heat capacity.

23. The method of claim 16 wherein a liquid hydrocarbon is used as the liquid having the known thermal volume expansion coefficient and the known volume heat capacity.

24. The method of claim 16 wherein any liquid component of the sample is used as the liquid having the known thermal volume expansion coefficient and the known volume heat capacity.
